(19) United States
(12) Patent Application Publication
(10) Pub. No.: US 2025/0382393 A1
(43) Pub. Date: Dec. 18, 2025

(54) AQUEOUS BINDER FOR PREPARING HARD CARBON ANODES OF SODIUM-ION BATTERIES AND A PREPARATION METHOD

(71) Applicant: ZHENGZHOU UNIVERSITY, Zhengzhou (CN)

(72) Inventors: Weihua CHEN, Zhengzhou (CN); Wenbin LI, Zhengzhou (CN); Chuntai LIU, Zhengzhou (CN)

(73) Assignee: ZHENGZHOU UNIVERSITY, Zhengzhou (CN)

(21) Appl. No.: 19/315,707

(22) Filed: Sep. 1, 2025

Related U.S. Application Data
(63) Continuation of application No. PCT/CN2024/079175, filed on Feb. 29, 2024.

(30) Foreign Application Priority Data
Mar. 1, 2023 (CN) 202310187515.6
Feb. 28, 2024 (CN) 202410218479.X

(51) Int. Cl. C08B 37/00; H01M 4/02; H01M 4/133; H01M 4/583; H01M 4/62; H01M 10/054

(52) U.S. Cl. CPC C08B 37/0069; H01M 4/133; H01M 4/583; H01M 4/622; H01M 4/625; H01M 2004/027; H01M 10/054

(57) ABSTRACT

An aqueous binder and its use in hard carbon anodes of sodium-ion batteries are provided. The aqueous binder includes a first component and a second component, the first component is one or more of sodium-ion-containing styrene derivative polymers or sodium-ion-containing pyran derivative polymers, and the second component is a conductive polymer containing ether bonds. By controlling addition amounts of the first component and the second component, an aqueous binder containing a large number of polar hydrophilic groups is obtained, which is suitable for hard carbon anodes of sodium-ion batteries. The aqueous binder features simple and convenient preparation, economical raw materials, and environmental friendliness with deionized water as the solvent. The sodium-ion battery prepared with the hard carbon anode using this aqueous binder has high initial Coulombic efficiency and good cycling stability and rate performance, thus showing promising prospects for commercial application.

### CROSS-REFERENCE TO RELATED APPLICATIONS

This application is a continuation of International Application No. PCT/CN2024/079175 filed on Feb. 29, 2024, which claims priority to Chinese Patent Application No. 202310187515.6 filed on Mar. 1, 2023, and Chinese Patent Application No. 202410218479.X filed on Feb. 28, 2024, the entire contents of each of which are incorporated herein by reference.

### TECHNICAL FIELD

This disclosure relates to the technical field of sodium-ion batteries, and in particular to an aqueous binder and its use in hard carbon anodes of sodium-ion batteries.

### BACKGROUND

Sodium-ion batteries are regarded as one of the most promising new-generation high-energy energy storage systems due to their advantages such as abundant sodium resources, high safety, and good low-temperature performance. Generally speaking, the electrode materials of sodium-ion batteries mainly consist of three parts: active materials, binders, and conductive agents. Among them, the binder system accounts for a very small proportion in the entire electrode system, but plays an important role in improving battery performance. The main function of the binder is to maintain the integrity of the electrode structure. Adding an appropriate amount of high-performance binder can enable the battery to obtain a larger capacity and a longer cycle life, and can also reduce the internal resistance of the battery, which is beneficial to improving the discharge platform and high-current discharge capability of the battery, reducing the internal resistance during low-rate charging, and enhancing the fast-charging capability of the battery. Hard carbon, as the most likely commercialized anode material due to its suitable sodium insertion potential, high safety, and low cost, still faces the problem of low initial efficiency. Its poor cycling and rate performance in ester electrolytes restrict the large-scale commercial application of hard carbon anode materials. Meanwhile, carbon materials have poor hydrophilicity and are difficult to disperse uniformly in water.

At present, the most commonly used binders are oil-based polyvinylidene fluoride (PVDF) and water-based carboxymethyl cellulose (CMC). As an oil-based binder, PVDF requires the use of N-methylpyrrolidone (NMP), a toxic and expensive organic substance, as a solvent, which is unfavorable to the environment and the control of production costs. Meanwhile, the main H—F bonds in PVDF are inactive, so they cannot provide sufficient force to connect electrode materials, which is not conducive to the long-cycle stability of the battery. As the most commonly used water-based binder, CMC contains a large number of functional groups and has a good fixing effect on electrode materials, but it has high brittleness, and the prepared hard carbon electrode is prone to powder shedding and slag dropping, which is not conducive to the long-term operation of the electrode, and its ionic conductivity still needs to be improved.

Therefore, in view of the problems of the above-mentioned commonly used binders, it is necessary to develop a new type of aqueous binder with excellent performance.

### SUMMARY

In view of the defects and deficiencies of existing binders, one or more embodiments of this disclosure provide an aqueous binder and its use in hard carbon anodes of sodium-ion batteries.

Using the aqueous binder to the hard carbon anodes of sodium-ion batteries can effectively improve the initial Coulombic efficiency, cycle stability and rate performance of the batteries.

To achieve the above objectives, the technical solution of the present disclosure is implemented as follows:

One or more embodiments of this disclosure provide an aqueous binder, which comprises a first component and a second component; the first component is one or more of sodium ion-containing pyran derivative polymers represented by Formula II; and the second component is a conductive polymer containing ether bonds:

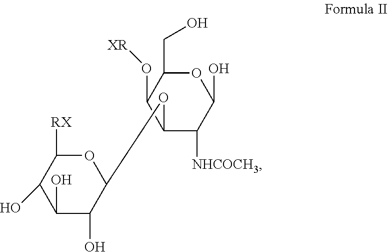

wherein R in Formula II is any one selected from —O— (ether linkage), —COO— (ester group), —CH— (methylene group), —CO—NH— (amide group), and —SO₃ (sulfonate group); and X is a sodium ion.

In some embodiments, the sodium ion-containing pyran derivative polymer is one or both of Sodium Chondroitin Sulfate A and Sodium Chondroitin Sulfate B.

In some embodiments, the sodium ion-containing pyran derivative polymer is one or both of Sodium Polyallylsulfonate and Sodium Chondroitin Sulfate C.

In some embodiments, the conductive polymer containing ether bonds is one of Polyethylene Oxide, Polypropylene Oxide, Polyethylene Diamine, and Polyepichlorohydrin.

In some embodiments, an average molecular weight of the first component is greater than 10,000; and an average molecular weight of the second component is within a range of 100,000-1,000,000.

In some embodiments, a molar percentage of the first component in the aqueous binder is within a range of 70%-90%; and a molar percentage of the second component in the aqueous binder is within a range of 10%-30%.

In some embodiments, a preparation method, which is used for preparing the above-mentioned aqueous binder, comprises the following steps: (a) dissolving the first component and the second component in a solvent, then mixing and stirring for 1-4 hours to obtain a mixed solution; and (b) drying the mixed solution obtained in step (a) at 60-100° C. to obtain the aqueous binder in a solid state.

In some embodiments, the solvent is deionized water; and a mass ratio of a total mass of the first component and the second component to the deionized water is 0.1:(1-3).

One or more embodiments of this disclosure provide a hard carbon anode for sodium-ion batteries, wherein the hard carbon anode for sodium-ion batteries comprises the aqueous binder according to claim 1, a hard carbon anode material, and a conductive agent.

In some embodiments, the conductive agent is any one of Acetylene Black, Ketjen Black, Carbon Nanotubes, Conductive Carbon Black and Graphene; the hard carbon anode material is a hard carbon material; and a mass ratio of the hard carbon anode material, the conductive agent and the aqueous binder is (16-19):(1-2):(1-3).

### BRIEF DESCRIPTION OF THE DRAWINGS

This disclosure will be further illustrated by way of exemplary embodiments, which will be described in detail with reference to the accompanying drawings. These embodiments are not restrictive, and in these embodiments, the same numbers denote the same structures, wherein:

FIG. 1 is a comparison diagram of swelling rates of the binders prepared in Example 3 and Comparative Examples 1 and 2.

FIG. 2 is an infrared spectrum of the binder of Example 3.

FIG. 3 is a scanning electron microscope image of the hard carbon anode sheets prepared in Example 9 and Comparative Examples 3 and 4.

FIG. 4 is a transmission electron microscope (TEM) image of Solid Electrolyte Interface (SEI) of the hard carbon anode sheets prepared in Example 9 and Comparative Examples 3 and 4 after the initial discharge.

FIG. 5 is a comparison diagram of initial charge-discharge curves of sodium-ion half-cells prepared using the hard carbon anode sheets of Example 7 and Comparative Examples 3 and 4.

FIG. 6 is a comparison diagram of initial charge-discharge curves of sodium-ion half-cells prepared using the hard carbon anode sheets of Example 10 and Comparative Examples 5 and 6.

FIG. 7 is a comparison diagram of cycling performance of sodium-ion half-cells prepared using the hard carbon anode sheets of Example 8 and Comparative Examples 3 and 4.

FIG. 8 is a comparison diagram of cycling performance of sodium-ion half-cells prepared using the hard carbon anode sheets of Example 9 and Comparative Examples 3 and 4.

FIG. 9 is an initial charge-discharge curve diagram of sodium-ion half-cells prepared using the hard carbon anode sheets of Example 11 and Example 12.

FIG. 10 is a cycling performance diagram of a sodium-ion full cell prepared using the hard carbon anode sheet of Example 9.

### DETAILED DESCRIPTION

The technical solutions in the embodiments of the present disclosure will be clearly and completely described below in conjunction with the accompanying drawings in the embodiments of the present disclosure. Obviously, the described embodiments are only a part of the embodiments of the present disclosure, rather than all the embodiments. Based on the embodiments of the present disclosure, all other embodiments obtained by those of ordinary skill in the art without creative work shall fall within the protection scope of the present disclosure.

The weights of the relevant components mentioned in the embodiments of the present disclosure can not only refer to a specific content of each component, but also represent a weight ratio relationship between the components. Therefore, any proportional enlargement or reduction of the content of the relevant components in accordance with the embodiments of the present disclosure shall fall within the scope disclosed in the embodiments of the present disclosure. Specifically, the weight described in the embodiments of the present disclosure can be g, mg, g, kg, and other mass units known in the chemical industry.

In the embodiments and comparative examples of the present disclosure, a molecular weight of PVDF is 500,000, a molecular weight of CMC is 90,000, a molecular weight of polyethylene oxide (PEO) is 1,000,000, an average molecular weight of poly(sodium 4-styrenesulfonate) is within a range of 60,000-100,000, a molecular weight of sodium polyanetholesulfonate is within a range of 10,000-20,000, a molecular weight of sodium chondroitin sulfate A is within a range of 40,000-50,000, a molecular weight of polypropylene oxide is 100,000, a molecular weight of sodium chondroitin sulfate B is within a range of 30,000-40,000, and a molecular weight of sodium chondroitin sulfate C is within a range of 40,000-50,000. All the above materials are purchased from the official website of Aladdin.

The hard carbon anode of sodium-ion batteries is a core electrode component of sodium-ion batteries. The hard carbon anode can realize charge storage through the intercalation/deintercalation of sodium ions in the hard carbon material. Hard carbon is regarded as an ideal anode material in sodium-ion batteries due to its advantages such as suitable sodium intercalation potential, high specific capacity, and low cost.

When preparing a hard carbon anode, usually, carbon materials that cannot be graphitized after high-temperature treatment are used as hard carbon, and the hard carbon anode is prepared by combining auxiliary materials such as conductive agents and binders. The type of binder has a great influence on the index parameters of the hard carbon anode.

Aqueous binder is a kind of binder with water as the solvent. Aqueous binders can bond hard carbon, conductive agents, etc. into electrodes, ensuring the structural integrity of the electrodes when sodium-ion batteries are in use. Compared with oil-based binders, aqueous binders have the advantages of being green and environmentally friendly, low in cost, and low in swelling rate. However, the hard carbon electrodes prepared with existing aqueous binders have high brittleness, which leads to powder shedding, slag dropping or even fragmentation of the electrodes, and it is difficult to regulate the stability of the electrode interface, resulting in a thick and uneven SEI film, which limits the performance of sodium-ion batteries.

In view of this, one or more embodiments of this disclosure provide an aqueous binder, the aqueous binder includes a first component and a second component; the first component is one or more of sodium ion-containing pyran derivative polymers represented by Formula II; and the second component is a conductive polymer containing ether bonds:

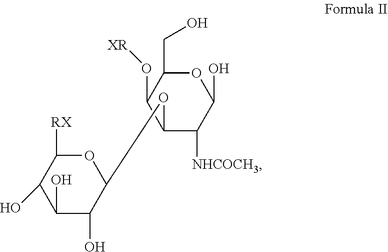

wherein R in Formula II is any one selected from —O— (ether linkage), —COO— (ester group), —CH₂-(methylene group), —CO—NH— (amide group), and —SO₃⁻ (sulfonate group); and X is a sodium ion.

Pyran derivative polymers are a class of polymer materials derived based on pyran ring structures. In some embodiments, the pyran derivative polymer is a polar compound, that is, a sodium ion-containing pyran derivative polymer.

In some embodiments, the sodium ion-containing pyran derivative polymer is one or both of Sodium Chondroitin Sulfate A and Sodium Chondroitin Sulfate B.

In some embodiments, the first component further includes one or more of Sodium Polyallylsulfonate and Sodium Chondroitin Sulfate C.

In some embodiments, the second component is a conductive polymer containing ether bonds. Conductive polymers are polymer materials with conductive capabilities.

In some embodiments, the type of conductive polymer containing ether bonds may be determined according to actual application scenarios and requirements. For example, conductive polymers containing ether bonds may include, but are not limited to, poly(3,4-ethylenedioxythiophene) (PEDOT), polyphenylene ether (PPE), and the like.

In some embodiments, the conductive polymer containing ether bonds includes one of Polyethylene Oxide, Polypropylene Oxide, Polyethylene Diamine, and Polyepichlorohydrin.

The aqueous binder provided in the present application includes, as the first component, one or more of sodium ion-containing styrene derivative polymers or sodium ion-containing pyran derivative polymers, and as the second component, a conductive polymer containing polar group ether bonds (C—O—C). Through dissolution and heating reaction, the polar functional groups in the two components interact to form hydrogen bonds, resulting in a fibrous polymer rich in polar hydrophilic groups. The fibrous network polymer rich in polar hydrophilic groups can react with the active functional groups (oxygen functional groups) on the surface of the hard carbon anode material, effectively coating the surface of the hard carbon anode material, improving the hydrophilicity of the hard carbon anode material, enhancing the dispersion degree of the carbon material in water, and helping the binder to mix more uniformly with the carbon material. This makes the surface of the hard carbon anode sheet of the sodium-ion battery containing the binder relatively flat, reduces the contact area between the electrode material and the electrolyte and the exposure of surface defects, thereby reducing excessive consumption of the electrolyte and the corresponding irreversible capacity loss, and improving the initial Coulombic efficiency of the sodium-ion battery. Meanwhile, polar groups can reduce the desolvation energy barrier, and the ether bond (—C—O—C—) groups contained in polyethylene oxide can form coordinate bonds with sodium ions through sufficient electron donor capacity, improving the ionic conductivity of the polymer electrolyte and enhancing the kinetic characteristics. The initial Coulombic efficiency of the sodium-ion half-cell using the aqueous binder of the present application is greater than 80%, and the specific capacity after 100 cycles can still reach 317 mAh/g; the sodium-ion full cell assembled with the hard carbon anode using the aqueous binder of the present application has good cycle stability, with a capacity retention rate of 74% after 150 cycles and an energy density as high as 181.05 Wh·kg⁻¹.

In some embodiments, the average molecular weights of the first component and the second component may be determined according to actual application scenarios and requirements.

In some embodiments, the average molecular weight of the first component is greater than 10,000; and the average molecular weight of the second component is within a range of 100,000-1,000,000.

In some embodiments, the average molecular weight of the first component is greater than 20,000.

In some embodiments, the average molecular weight of the first component is greater than 50,000.

In some embodiments, the average molecular weight of the first component is greater than 100,000.

In some embodiments, the average molecular weight of the first component is greater than 150,000.

In some embodiments, the average molecular weight of the first component is greater than 200,000.

In some embodiments, the average molecular weight of the second component may also be one of 100,000, 200,000, 300,000, 400,000, 500,000, 600,000, 700,000, 800,000, 900,000, 1,000,000, etc.

In some embodiments, the average molecular weight of the second component may also be one of ranges of 100,000-300,000, 300,000-500,000, 500,000-700,000, 700,000-900,000, 200,000-600,000, 100,000-400,000, 400,000-700,000, 700,000-1,000,000, 200,000-500,000, 500,000-800,000, 500,000-1,000,000, etc.

The average molecular weights of the first component and the second component are not limited to the listed values, and other unlisted values within the numerical ranges are also applicable.

In some embodiments of the present disclosure, by setting the average molecular weight of the first component to be greater than 10,000 and the average molecular weight of the second component to be within a range of 100,000-1,000,000, the aqueous binder can be ensured to have appropriate viscosity and toughness, so as to guarantee the bonding performance of the aqueous binder and avoid powder shedding, slag dropping or even fragmentation of the hard carbon electrode.

In some embodiments, the proportions of the first component and the second component in the aqueous binder maybe determined according to actual application scenarios and requirements.

In some embodiments, the molar percentage of the first component in the aqueous binder is within a range of 70%-90%; and the molar percentage of the second component in the aqueous binder is within a range of 10%-30%.

In some embodiments, the molar percentages of the first component and the second component are one of 70% and 30%, 75% and 25%, 80% and 20%, 85% and 15%, 90% and 10%, etc. The molar percentages of the first component and the second component are not limited to the listed values, and other unlisted values within the numerical ranges are also applicable.

In some embodiments of the present disclosure, by setting the molar percentage of the first component in the aqueous binder to be within a range of 70%-90% and the molar percentage of the second component in the aqueous binder to be within a range of 10%-30%, the ratio of polar hydrophilic groups to conductive ether bonds can be regulated. While ensuring good dispersibility of the hard carbon material, the transport effect of ether bonds on sodium ions is maximized, a thin and uniform SEI film is formed, electrolyte decomposition is reduced, and the initial Coulombic efficiency and long-term cycle stability of the battery are improved.

Some embodiments of the present disclosure provide a preparation method, which is used for preparing the above aqueous binder, comprising the following steps:
(a) dissolving the first component and the second component in a solvent, then mixing and stirring for 1-4 hours to obtain a mixed solution.

In some embodiments, the solvent used in step (a) maybe determined based on actual application scenarios and requirements. For example, the solvent maybe an aqueous solution containing inorganic salts (such as sodium chloride, sodium carbonate, etc.), an aqueous solution containing additives (such as pH regulators, pigments, defoamers, surfactants, stabilizers, complexing agents, etc.), an aqueous solution containing polar solvents (such as glycerol, methanol, ethanol, ethylene glycol, propylene glycol, etc.), and the like.

In some embodiments, the mass ratio of the total mass of the first component and the second component to the solvent maybe determined according to actual application scenarios and requirements.

In some embodiments, the solvent used in step (a) is deionized water; and the mass ratio of the total mass of the first component and the second component to deionized water is 0.1:(1-3).

In some embodiments, the mass ratio of the total mass of the first component and the second component to deionized water may also be one of 0.1:1, 0.1:1.2, 0.1:1.5, 0.1:2, 0.1:2.4, 0.1:2.8, 0.1:3, etc.

In some embodiments, the mass ratio of the total mass of the first component and the second component to deionized water may also be one of 0.1:(1-1.2), 0.1:(1.2-1.5), 0.1:(1.5-2), 0.1:(2-2.4), 0.1:(2.4-2.8), 0.1:(2.8-3), 0.1:(1-1.5), 0.1:(1.2-2), 0.1:(1.5-2.4), 0.1:(2-2.8), etc.

(b) drying the mixed solution obtained in step (a) at 60-100° C. to obtain the aqueous binder in a solid state.

In some embodiments, the drying temperature maybe one of 60° C., 70° C., 80° C., 90° C., 100° C., etc.

In some embodiments, the drying temperature maybe one of ranges of 60-70° C., 70-80° C., 80-90° C., 90-100° C., 60-80° C., 70-90° C., 80-100° C., 60-90° C., 70-100° C., 60-100° C., etc.

In some embodiments of the present disclosure, by setting the solvent as deionized water and the mass ratio as 0.1:(1-3), it can ensure that the binder components are fully dissolved and form a homogeneous solution, so as to ensure the uniformity of the aqueous binder and thus guarantee the bonding performance of the aqueous binder.

The swelling rate of the aqueous binder prepared in the present application does not exceed 30%, which is significantly lower than that of the oil-based binder PVDF and the aqueous binder CMC. The volume change in the electrolyte is small, which helps to maintain the integrity of the electrode structure and the rapid transport of sodium ions. The preparation method of the aqueous binder of the present application is simple and convenient, the raw materials are economical, deionized water is used as the solvent which is green and environmentally friendly, and the sodium-ion battery using the aqueous binder has high initial Coulombic efficiency, cycle stability and rate performance, thus having good prospects for commercial application.

Some embodiments of the present disclosure provide a hard carbon anode for sodium-ion batteries, comprising the above aqueous binder, a hard carbon anode material, and a conductive agent.

Hard carbon is a carbon material with an amorphous or short-range ordered structure. Hard carbon is usually made of carbon that cannot be graphitized after high-temperature treatment, and has high disorder, developed pore structure and good interlayer spacing, which is suitable for the intercalation and deintercalation of sodium ions.

In some embodiments, the hard carbon may be prepared by oneself or commercial raw materials maybe used.

The conductive agent is an additive that improves the conductive performance of the electrode material. The type of conductive agent maybe determined according to actual application scenarios and requirements. For example, the conductive agent may include, but is not limited to, vapor-grown carbon fiber (VGCF), fluorinated graphite, organic conductive compounds (e.g., thienyltriazine derivatives), conductive metal powders (e.g., silver powder, copper powder, nickel powder), and the like.

The mass ratio of the hard carbon anode material, the conductive agent, and the aqueous binder maybe determined according to actual application scenarios and requirements.

In some embodiments, the conductive agent is any one of Acetylene Black, Ketjen Black, Carbon Nanotubes, Conductive Carbon Black, and Graphene; the hard carbon anode material is a hard carbon material; and the mass ratio of the hard carbon anode material, the conductive agent, and the aqueous binder is (16-19):(1-2):(1-3).

In some embodiments, the mass ratio of the hard carbon anode material, the conductive agent, and the aqueous binder is one of 16:1:1, 17:1.5:2, 18:2:3, 19:1:2, 16:1.5:3, 17:2:1, 18:1:3, 19:1.5:2, 16:2:2, 17:1:1, etc.

In some embodiments, the mass ratio of the hard carbon anode material, the conductive agent, and the aqueous binder is one of (16-17):(1-1.5):(1-2), (16-18):(1-2):(1-3), (17-19):(1.5-2):(2-3), (18-19):(1-1.5):(1-3), (16-19):(1.5-2):(1-2), (17-18):(1-2):(2-3), etc.

In some embodiments of the present disclosure, by setting the conductive agent as any one of Acetylene Black, Ketjen Black, Carbon Nanotubes, Conductive Carbon Black, and Graphene; the hard carbon anode material as a hard carbon material; and the mass ratio of the hard carbon anode material, the conductive agent, and the aqueous binder as (16-19):(1-2):(1-3), a balance can be achieved among the electrical conductivity of the electrode, the sodium ion adsorption performance, and the mechanical strength of the electrode, ensuring that the sodium-ion battery has high energy density while maintaining a long service life.

In the sodium-ion battery with the aqueous binder of the present application, since the binder covering the surface of the hard carbon electrode has a large number of strong electronegative groups, it can effectively adsorb sodium ions, reduce the desolvation barrier of sodium ions, accelerate the desolvation process, and reduce the decomposition of organic solvents on the electrode surface, thereby forming a relatively thin SEI; meanwhile, the strongly polar functional groups in the two components can adsorb anions in the electrolyte to the electrode surface, thereby accelerating the decomposition of anions to form an SEI rich in inorganic substances. The thin SEI rich in inorganic substances helps to maintain the stability of the interface, reduce the interface impedance, and improve the initial Coulombic efficiency, long-cycle performance, and rate performance of the battery. In addition, the complexed sodium salt in the first component can supplement the consumption of irreversible sodium ions during the sodium intercalation process of the sodium-ion battery, playing a role in sodium supplementation, which is beneficial to improving the initial Coulombic efficiency and cycle stability of the sodium-ion battery.

The following takes the preparation of the aqueous binder as an example to further illustrate the aqueous binder for preparing hard carbon anodes of sodium-ion batteries and its preparation method provided by some embodiments of the present disclosure.

### Example 1

This example prepared an aqueous binder, which included 0.18 g of poly(sodium 4-styrenesulfonate), 0.02 g of PEO, and 4 mL of deionized water. The preparation steps were as follows:

(a) Add poly(sodium 4-styrenesulfonate) and PEO into a sample bottle, add deionized water to dissolve them, stir for 3 hours, and after mixing uniformly, obtain a mixed solution rich in polar functional groups.

(b) React and dry the mixed solution from step (a) at 80° C. to obtain a solid film of the aqueous binder.

### Example 2

This example prepared an aqueous binder, which included 0.16 g of sodium polyanetholesulfonate, 0.04 g of PEO, and 4 mL of deionized water. The preparation steps were as follows:

(a) Add sodium polyanetholesulfonate and PEO into a sample bottle, add deionized water to dissolve them, stir for 3 hours, and after mixing uniformly, obtain a mixed solution rich in polar functional groups.

(b) React and dry the mixed solution from step (a) at 80° C. to obtain a solid of the aqueous binder.

### Example 3

This example prepared an aqueous binder, which included 0.18 g of Sodium Chondroitin Sulfate A, 0.02 g of PEO, and 4 mL of deionized water. The preparation steps were as follows:

(a) Add Sodium Chondroitin Sulfate A and PEO into a sample bottle, add deionized water to dissolve them, stir for 3 hours, and after mixing uniformly, obtain a mixed solution rich in polar functional groups.

(b) React and dry the mixed solution from step (a) at 80° C. to obtain a solid of the aqueous binder.

### Example 4

This example prepared an aqueous binder, which included 0.16 g of Sodium Chondroitin Sulfate B, 0.04 g of Polypropylene Oxide, and 4 mL of deionized water. The preparation steps were as follows:

(a) Add Sodium Chondroitin Sulfate B and Polypropylene Oxide into a sample bottle, add deionized water to dissolve them, stir for 3 hours, and after mixing uniformly, obtain a mixed solution rich in polar functional groups.

(b) React and dry the mixed solution from step (a) at 80° C. to obtain a solid of the aqueous binder.

### Example 5

This example prepared an aqueous binder, which included 0.14 g of polystyrene-co-sodium styrenesulfonate, 0.06 g of Polyethylene Diamine, and 4 mL of deionized water. The preparation steps were as follows:

(a) Add polystyrene-co-sodium styrenesulfonate and Polyethylene Diamine into a sample bottle, add deionized water to dissolve them, stir for 3 hours, and after mixing uniformly, obtain a mixed solution rich in polar functional groups.

(b) React and dry the mixed solution from step (a) at 80° C. to obtain a solid of the aqueous binder.

### Example 6

This example prepared an aqueous binder, which included 0.08 g of Sodium Chondroitin Sulfate C, 0.02 g of Polyepichlorohydrin, and 3 mL of deionized water. The preparation steps were as follows:

(a) Add Sodium Chondroitin Sulfate C and Polyepichlorohydrin into a sample bottle, add deionized water to dissolve them, stir for 3 hours, and after mixing uniformly, obtain a mixed solution rich in polar functional groups.

(b) React and dry the mixed solution from step (a) at 60° C. to obtain a solid of the aqueous binder.

### Examples 7-15

Hard carbon anode sheets of sodium-ion batteries were prepared using the aqueous binder solids prepared in Examples 1-6, solvent water, as well as different electrode materials and conductive agents, by the following method: The electrode material (hard carbon anode material), conductive agent, and binder were weighed and mixed uniformly in different mass ratios, then deionized water was added and stirred to mix uniformly to prepare a battery sheet slurry; the battery sheet slurry was evenly coated on the current collector copper foil with a scraper, and dried in a blast drying oven at 80° C. for 8 hours to obtain the hard carbon anode sheets of sodium-ion batteries.

The types and proportions of the specifically used electrode materials, conductive agents, and aqueous binders are shown in Table 1.

TABLE 1
Materials and proportions used in the hard carbon anode
sheets of sodium-ion batteries in Examples 7-15

| | | | | Mass ratio of | | |
|---|---|---|---|---|---|---|
| | | | | electrode | | |
| | | | | material, | | |
| | | | | conductive | | |
| | Electrode | Conductive | | agent, and | | |
| Example | material | agent | Binder | binder | Solvent | Electrode |
| 7 | Hard carbon | Conductive | Example | 8:1:1 | Water | Anode |
| | (Sodium | Carbon | 1 | | | |
| | Innovation | Black | | | | |
| | Energy) | | | | | |
| 8 | Hard carbon | Acetylene | Example | 8:1:1 | Water | Anode |
| | (Sodium | Black | 2 | | | |
| | Innovation | | | | | |
| | Energy) | | | | | |
| 9 | Hard carbon | Conductive | Example | 8:1:1 | Water | Anode |
| | (Sodium | Carbon | 3 | | | |
| | Innovation | Black | | | | |
| | Energy) | | | | | |
| 10 | Hard Carbon | Conductive | Example | 8:1:1 | Water | Anode |
| | (Kuraray) | Carbon | 3 | | | |
| | | Black | | | | |
| 11 | Hard carbon | Conductive | Example | 8:1:1 | Water | Anode |
| | (Sodium | Carbon | 4 | | | |
| | Innovation | Black | | | | |
| | Energy) | | | | | |
| 12 | Hard Carbon | Acetylene | Example | 8:1:1 | Water | Anode |
| | (Kuraray) | Black | 5 | | | |
| 13 | Hard Carbon | Acetylene | Example | 8:1:1 | Water | Anode |
| | (Kuraray) | Black | 6 | | | |
| 14 | Hard carbon | Conductive | Example | 7:2:1 | Water | Anode |
| | (Sodium | Carbon | 3 | | | |
| | Innovation | Black | | | | |
| | Energy) | | | | | |
| 15 | Hard carbon | Conductive | Example | 8:1.5:1 | Water | Anode |
| | (Sodium | Carbon | 3 | | | |
| | Innovation | Black | | | | |
| | Energy) | | | | | |

### Comparative Example 1

This comparative example prepared an oil-based binder, PVDF was selected as the binder, and NMP solvent was used as the solvent.

Weigh 0.3 g of PVDF, dissolve it in 9.7 mL of NMP solvent, and stir to obtain a 3% PVDF binder solution; take 5 mL of the 3% PVDF binder solution and dry it at 80° C. for 8 hours to obtain a PVDF film.

### Comparative Example 2

This comparative example prepared an aqueous binder, CMC was selected as the binder, and water was selected as the solvent.

Weigh 0.3 g of CMC, dissolve it in 5.7 mL of water solvent, and stir to obtain a 5% CMC binder solution; take 5 mL of the 5% CMC binder solution and dry it at 80° C. for 8 hours to obtain a CMC film.

### Comparative Examples 3-6

Hard carbon anode sheets of sodium-ion batteries were prepared using the binders obtained in Comparative Examples 1-2, as well as different solvents, electrode materials (hard carbon anode materials) and conductive agents, by the following method. The electrode material, conductive agent, and binder were weighed in a mass ratio of 8:1:1 and mixed uniformly, then deionized water (or NMP) was added and stirred to mix uniformly to prepare a battery sheet slurry; the battery sheet slurry was evenly coated on a current collector copper foil (or aluminum foil) with a scraper, and dried in a blast drying oven at 80° C. for 8 hours to obtain the hard carbon anode sheets of sodium-ion batteries.

The types and proportions of the specifically used electrode materials, conductive agents and aqueous binders are shown in Table 2.

TABLE 2
Materials and proportions used in the hard carbon anode sheets
of sodium-ion batteries in Comparative Examples 3-6

| | | | | Mass | |
|---|---|---|---|---|---|
| | | | | ratio of | |
| | | | | electrode | |
| | | | | material, | |
| | | | | conductive | |
| Comparative | Electrode | Conductive | | agent | |
| Example | material | agent | Binder | and binder | Solvent |
| 3 | Hard | Conductive | Comparative | 8:1:1 | NMP |
| | carbon | Carbon | example 1 | | |
| | (Sodium | Black | | | |
| | Innovation | | | | |
| | Energy) | | | | |
| 4 | Hard | Conductive | Comparative | 8:1:1 | Water |
| | carbon | Carbon | example 2 | | |
| | (Sodium | Black | | | |
| | Innovation | | | | |
| | Energy) | | | | |
| 5 | Hard | Conductive | Comparative | 8:1:1 | NMP |
| | Carbon | Carbon | example 1 | | |
| | (Kuraray) | Black | | | |
| 6 | Hard | Conductive | Comparative | 8:1:1 | Water |
| | Carbon | Carbon | example 2 | | |
| | (Kuraray) | Black | | | |

### Example of Implementation Effect

(1) Coin-type half-cells were assembled using the hard carbon anode sheets of sodium-ion batteries of Examples 7-15 and Comparative Examples 3-6, following the method below. The prepared hard carbon anode sheets were punched into small discs with a diameter of 13 mm, and then the discs, separators, electrolyte, sodium sheets, springs, and gaskets were encapsulated with positive and negative electrode cases in an argon-filled glove box to obtain 2025 coin-type half-cells. The electrolyte used was a 1M NaPF₆ solution in ethylene carbonate (EC)/dimethyl carbonate (DMC) (with a volume ratio of 1:1).

The cycle stability and rate capability of each sodium-ion half-cell were tested by the constant current method, with a potential window of 0.01-2 V for the hard carbon anode material and a current density of 50 mA/g; the test results are shown in Table 3.

TABLE 3
Performance test results of sodium-ion half-cells
in Examples 7-15 and Comparative Examples 3-6

| | Initial | |
|---|---|---|
| Reference | Coulombic | |
| Number | Efficiency | Capacity retention |
| Example 7 | 84% | 353 mAh/g (35 cycle) |
| Example 8 | 82% | 308 mAh/g (50 cycle) |
| Example 9 | 84% | 317 mAh/g (100 cycle) |
| Example 10 | 85% | 330 mAh/g (7 cycle) |
| Example 11 | 83% | 303 mAh/g (50 cycle) |
| Example 12 | 81% | 299 mAh/g (40 cycle) |
| Example 13 | 81% | 302 mAh/g (50 cycle) |
| Example 14 | 82% | 300 mAh/g (45 cycle) |
| Example 15 | 82% | 306 mAh/g (5 cycle) |
| Comparative | 75% | 294 mAh/g (50 cycle) |
| Example 3 | | |
| Comparative | 80% | 279 mAh/g (50 cycle) |
| Example 4 | | |
| Comparative | 79% | 276 mAh/g (7 cycle) |
| Example 5 | | |
| Comparative | 81% | 255 mAh/g (7 cycle) |
| Example 6 | | |

As can be seen from the data in Table 3, the sodium-ion half-cells of Examples 7-15 using the aqueous binder of the present disclosure generally have higher initial Coulombic efficiency, and the specific capacity after a certain number of cycles is improved to a certain extent compared with that of the sodium-ion half-cells of Comparative Examples 3-6. This indicates that the aqueous binder prepared by the present disclosure is well suitable for the hard carbon anode of sodium-ion batteries and plays an important role in improving the performance of sodium-ion batteries.

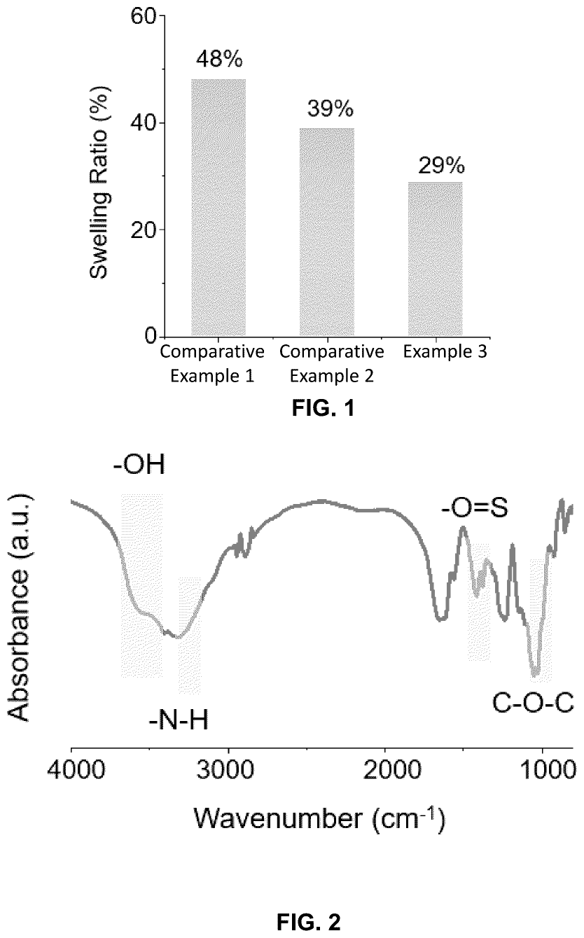

FIG. 1 shows the swelling ratio of the aqueous binder of Example 3 and the binders of Comparative Example 1 and Comparative Example 2 in organic solvents (the test method refers to the literature: Xia J., Z. Wang, N. D. Rodrig, et al. Super-Reversible CuF₂ Cathodes Enabled by Cu²⁺—Coordinated Alginate[J]. Adv. Mater., 2022, 34(43)). It can be seen that the aqueous binder of Example 3 has the lowest swelling ratio, indicating that its volume change in the electrolyte is small, which is beneficial to maintaining the integrity of the electrode structure. At the same time, the lower swelling ratio is also conducive to the rapid transport of sodium ions.

FIG. 2 is the infrared spectrum of the binder of Example 3. Characteristic peaks at 3564, 3304, 1418 and 1047 cm⁻¹ can be observed, which belong to —OH, —NH, —S═O and C—O—C bonds respectively. It can be confirmed that this aqueous binder contains a variety of polar functional groups, which can better combine with the oxygen-containing functional groups on the surface of hard carbon, improve its dispersion degree, and contribute to the smoothness of the electrode sheet and the enhancement of the bonding effect on the electrode.

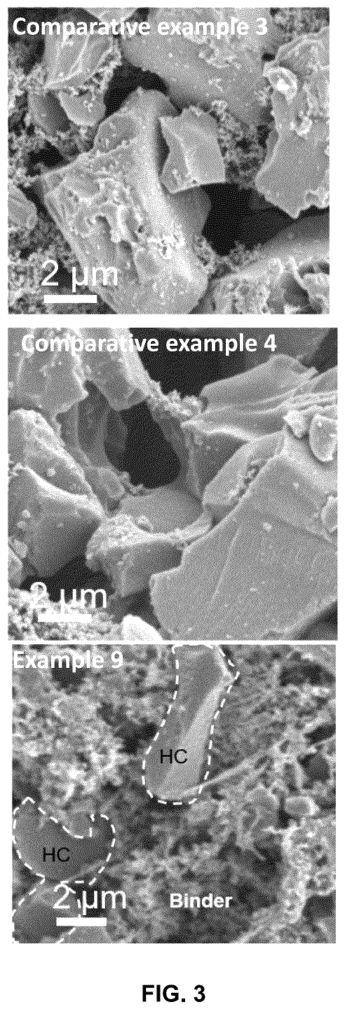

FIG. 3 is the scanning electron microscope (SEM) images of the hard carbon anode sheets of Example 9, Comparative Example 3, and Comparative Example 4. It can be seen from the images that there are obvious fibrous binders on the surface of the hard carbon anode sheet of Example 9, indicating that the binder and hard carbon are mixed more uniformly, and the adhesion between materials is tighter than that of Comparative Examples 3 and 4. This can reduce the contact between defects on the electrode and the electrolyte, thereby reducing excessive consumption of the electrolyte and helping to improve the initial coulombic efficiency and cycle stability of the battery.

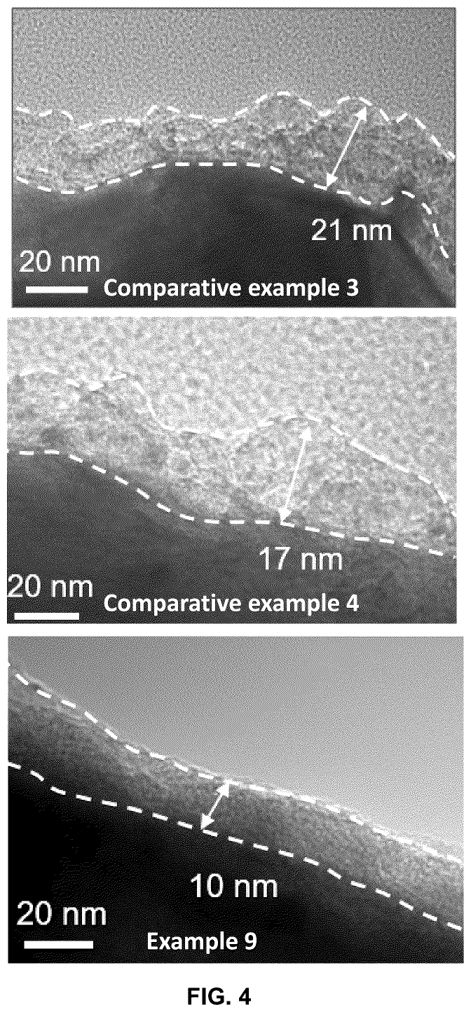

FIG. 4 is the transmission electron microscope (TEM) images of the solid electrolyte interphase (SEI) of the hard carbon anode sheets of Example 9, Comparative Example 3, and Comparative Example 4 after the first cycle of discharge. It can be seen that the SEI formed on the electrode surface induced by the aqueous binder of the present disclosure is thinner (10 nm) and more uniform, while the SEI of Comparative Examples 3 and 4 is thicker and non-uniform. A thinner SEI indicates less electrolyte consumption on the electrode surface, and a uniform interface helps to improve the transport rate of sodium ions, thereby enhancing its kinetic properties and cycle stability. A thicker SEI indicates that the electrolyte will be excessively consumed, and it is not conducive to the rapid transport of sodium ions, which in turn leads to lower initial Coulombic efficiency and cycle stability of the battery.

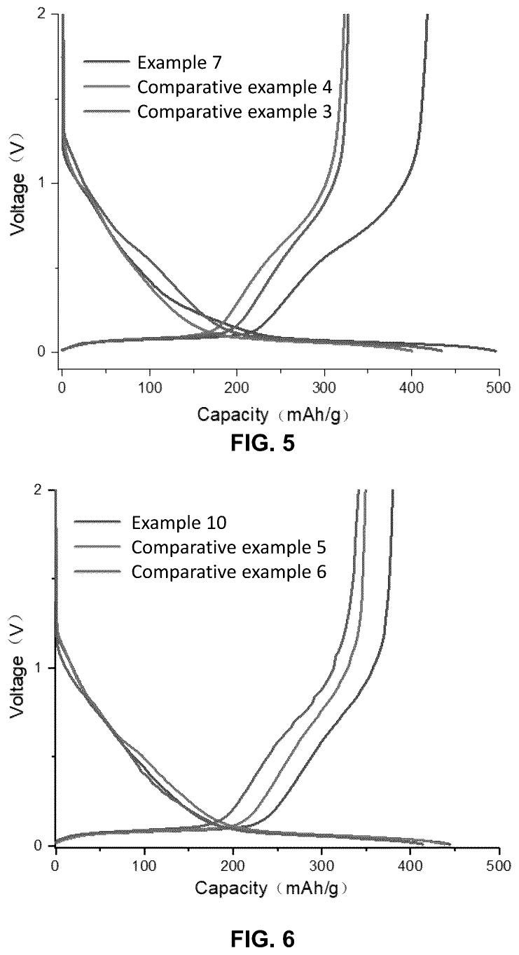

FIG. 5 is a comparison diagram of the initial charge-discharge curves of sodium-ion half-cells prepared using the hard carbon anode sheets of Example 7, Comparative Example 3, and Comparative Example 4. FIG. 6 is a comparison diagram of the initial charge-discharge curves of sodium-ion half-cells prepared using the hard carbon anode sheets of Example 10, Comparative Example 5, and Comparative Example 6. Combining FIGS. 5 and 6, it can be seen that the hard carbon anode using the aqueous binder of the present disclosure has a higher specific charge capacity, indicating that the irreversible capacity of the electrode is significantly reduced compared with the comparative examples. For example, excessive electrolyte consumption caused by surface defects is greatly reduced, and the overall polarization of the electrode is small, which is beneficial to the long-cycle stability of the battery.

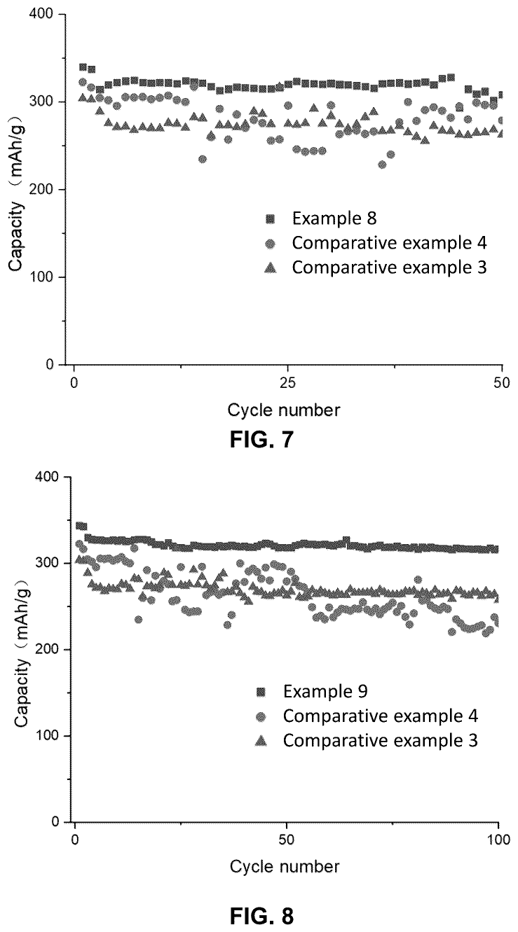

FIGS. 7 and 8 are comparison diagrams of cycle performance of sodium-ion half-cells prepared using hard carbon anode sheets from different Examples and Comparative Examples. It can be seen that the hard carbon anodes using the aqueous binder of the present disclosure have higher specific capacity and cycle stability. The high-performance SEI induced by the binder is beneficial to the long-cycle performance of the battery, indicating that the binder plays a significant role in aspects such as the cycle stability of the battery.

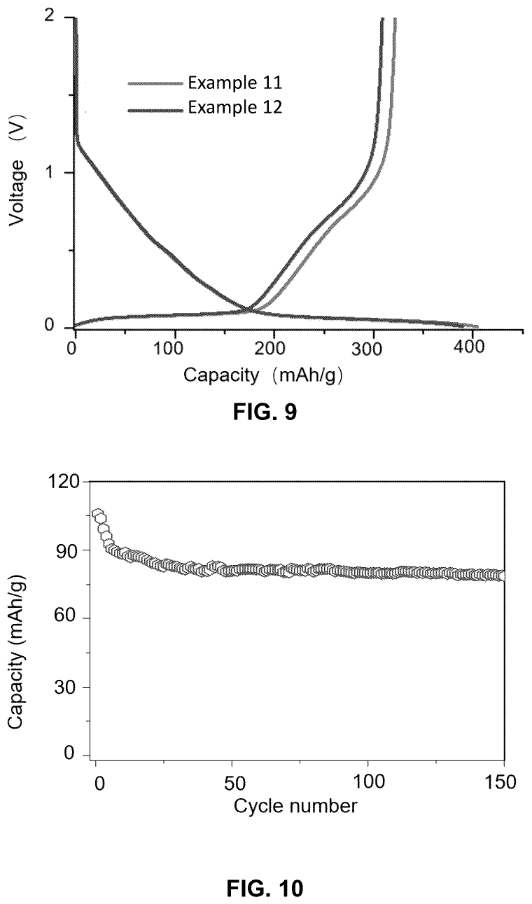

FIG. 9 is a comparison diagram of the initial charge-discharge curves of sodium-ion half-cells prepared using hard carbon anode sheets of Examples 11 and 12. It can be seen that by adjusting the ratio of the first component to the second component of the binder, the hard carbon anode material can still maintain a high initial Coulombic efficiency, indicating that binders with different ratios can still induce high-performance SEI, which is beneficial to the cycle stability of the battery.

(2) The hard carbon anode sheet prepared in Example 9 was matched with a commercial sodium vanadium phosphate cathode sheet to assemble a sodium-ion full cell. The dried electrode sheets were punched into small discs with a diameter of 13 mm, and then the electrode sheets, separator, electrolyte, spring, and gasket were encapsulated with positive and negative electrode cases in an argon-filled glove box to obtain a 2032 coin-type full cell. The electrolyte used was a 1M NaPF₆ solution in ethylene carbonate (EC)/dimethyl carbonate (DMC) (with a volume ratio of 1:1); and the n/p ratio was 1.1:1.

The cycle stability of the sodium-ion full cell was tested by the constant current method, with a potential window of 2-3.9 V and a current density of 59 mA/g. FIG. 10 is the cycle performance diagram of the sodium-ion full cell, indicating that the full cell assembled with the anode using the aqueous binder of the present disclosure has good cycle stability, with a capacity retention rate of 74% after 150 cycles and an energy density as high as 181.05 Wh·kg⁻¹. This shows that the aqueous binder has good prospects for commercial application.

The basic concepts have been described above. Obviously, for those skilled in the art, the above detailed disclosure is merely an example and does not constitute a limitation to the present disclosure. Although not explicitly stated herein, those skilled in the art may make various modifications, improvements, and corrections to the present disclosure. Such modifications, improvements, and corrections are suggested in the present disclosure, so such modifications, improvements, and corrections still fall within the spirit and scope of the exemplary embodiments of the present disclosure.

Meanwhile, the present disclosure uses specific words to describe the embodiments of the present disclosure. Terms such as “one embodiment”, “an embodiment”, and/or “some embodiments” mean a certain feature, structure, or characteristic related to at least one embodiment of the present disclosure. Therefore, it should be emphasized and noted that references to “an embodiment” or “one embodiment” or “an alternative embodiment” in different places in the present disclosure do not necessarily refer to the same embodiment. In addition, certain features, structures, or characteristics in one or more embodiments of the present disclosure may be appropriately combined.

For each patent, patent application, patent application publication, and other materials cited in the present disclosure, such as articles, books, specifications, publications, documents, etc., their entire contents are hereby incorporated into the present disclosure as references. Except for the application history documents that are inconsistent with or conflict with the contents of the present disclosure, and except for documents (currently or subsequently attached to the present disclosure) that limit the broadest scope of the claims of the present disclosure. It should be noted that if there is any inconsistency or conflict between the descriptions, definitions, and/or usage of terms in the supplementary materials of the present disclosure and the contents described in the present disclosure, the descriptions, definitions, and/or usage of terms in the present disclosure shall prevail.

Finally, it should be understood that the embodiments described in the present disclosure are only for illustrating the principles of the embodiments of the present disclosure. Other variations may also fall within the scope of the present disclosure. Therefore, by way of example rather than limitation, alternative configurations of the embodiments of the present disclosure may be considered consistent with the teachings of the present disclosure. Correspondingly, the embodiments of the present disclosure are not limited to the embodiments explicitly introduced and described in the present disclosure.

What is claimed is:

1. An aqueous binder, wherein the aqueous binder comprises a first component and a second component; the first component is one or more of sodium ion-containing pyran derivative polymers represented by Formula II; and the second component is a conductive polymer containing ether bonds: 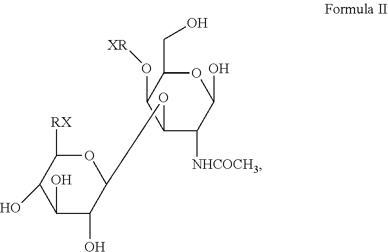
wherein R in Formula II is any one selected from —O— (ether linkage), —COO— (ester group), —CH₂— (methylene group), —CO—NH— (amide group) and —SO₃⁻ (sulfonate group); and X is a sodium ion.

2. The aqueous binder according to claim 1, wherein the sodium ion-containing pyran derivative polymer is one or both of Sodium Chondroitin Sulfate A and Sodium Chondroitin Sulfate B.

3. The aqueous binder according to claim 1, wherein the first component further includes one or more of Sodium Polyallylsulfonate and Sodium Chondroitin Sulfate C.

4. The aqueous binder according to claim 1, wherein the conductive polymer containing ether bonds is one of Polyethylene Oxide, Polypropylene Oxide, Polyethylene Diamine, and Polyepichlorohydrin.

5. The aqueous binder according to claim 1, wherein an average molecular weight of the first component is greater than 10,000; and an average molecular weight of the second component is within a range of 100,000-1,000,000.

6. The aqueous binder according to claim 1, wherein a molar percentage of the first component in the aqueous binder is within a range of 70%-90%; and a molar percentage of the second component in the aqueous binder is within a range of 10%-30%.

7. A preparation method, which is used for preparing the aqueous binder according to claim 1, comprising the following steps:
(a) dissolving the first component and the second component in a solvent, then mixing and stirring for 1-4 hours to obtain a mixed solution; and
(b) drying the mixed solution obtained in step (a) at 60-100° C. to obtain the aqueous binder in a solid state.

8. The preparation method according to claim 7, wherein the solvent is deionized water; and
a mass ratio of a total mass of the first component and the second component to the deionized water is 0.1:(1-3).

9. A hard carbon anode for sodium-ion batteries, wherein the hard carbon anode for sodium-ion batteries comprises the aqueous binder according to claim 1, a hard carbon anode material, and a conductive agent.

10. The hard carbon anode for sodium-ion batteries according to claim 9, wherein the conductive agent is any one of Acetylene Black, Ketjen Black, Carbon Nanotubes, Conductive Carbon Black, and Graphene; the hard carbon anode material is a hard carbon material; and a mass ratio of the hard carbon anode material, the conductive agent, and the aqueous binder is (16-19):(1-2):(1-3).
